(19) United States
(12) Patent Application Publication
(10) Pub. No.: US 2011/0023130 A1
(43) Pub. Date: Jan. 27, 2011

(54) Smart Battery System and Methods of Use

(76) Inventors: Judson Mannon Gudgel, Tulsa, OK (US); Jonathan D. Fairchild, Broken Arrow, OK (US); Martin Alan Moon, Tulsa, OK (US); Reed Jules Oppenheimer, Tulsa, OK (US)

Correspondence Address: Mossman, Kumar & Tyler PC, P.O. Box 421239, Houston, TX, 77242, US

(21) Appl. No.: 12/744,765

(22) PCT Filed: Nov. 26, 2008
(86) PCT No.: PCT/US08/84836

§ 371 Date: Sep. 24, 2010

Related U.S. Application Data
(60) Provisional application No. 60/990,158, filed on Nov. 26, 2007.

(51) Int. Cl. H02J 7/00; G06F 12/00; G06F 21/24

(52) U.S. Cl. 726/28; 320/106; 320/137; 711/154; 711/E12.001

(57) ABSTRACT

A battery pack including a housing; at least one battery cell associated with the housing; at least one memory element associated with the housing; at least one electrical connection associated with the housing for supplying power from the battery cell to the electronic device; and at least one communication interface associated with the housing for receiving data from the electronic device for storage in the memory element and/or for sending data from the memory element to the electronic device can be used for powering electronic devices. The battery pack may be used to increase the efficiency of employment of the electronic devices by storing the data generated by the electronic devices allowing the devices to be immediately redeployed by replacing the battery packs, the data being available for downloading from the battery pack. The battery packs may also be useful in advertising and software distribution systems.

### BACKGROUND OF THE INVENTION

1. Technical Field

The present invention relates to a battery system for use in powering electronic devices. The present invention particularly relates to the use of such batteries for both powering devices and uploading information to the devices.

2. Background of the Art

Batteries are devices for chemically storing electric power and have long been used to power electronic devices. These devices have been especially useful in applications where the electronic devices are intended to be used independent of fixed power supplies. For example, portable devices often are powered by batteries.

Batteries are of two basic types. The first are those that are considered to be non-rechargeable. These batteries are often referred to in the art as dry cell batteries. A “dry-cell” battery is essentially comprised of a metal electrode or graphite rod (elemental carbon) surrounded by a moist electrolyte paste enclosed in a metal cylinder. In the most common type of dry cell battery, the cathode is composed of a form of elemental carbon called graphite, which serves as a solid support for the reduction half-reaction. In an acidic dry cell, the reduction reaction occurs within the moist paste comprised of ammonium chloride (NHCl₄) and manganese dioxide (MnO₂).

A thin zinc cylinder serves as the anode and it undergoes oxidation. This dry cell “couple” produces about 1.5 volts. These “dry cells” can also be linked in series to boost the voltage produced. In the alkaline version or “alkaline battery”, the ammonium chloride is replaced by KOH or NaOH.

Other types of dry cell batteries are the silver battery in which silver metal serves as an inert cathode to support the reduction of silver oxide (Ag2O) and the oxidation of zinc (anode) in a basic medium. The type of battery commonly used for calculators is the mercury cell. In this type of battery, HgO serves as the oxidizing agent (cathode) in a basic medium, while zinc metal serves as the anode.

The second type of batteries is the rechargeable batteries. There are three basic types of rechargeable batteries: nickel cadmium, nickel metal hydride, and lithium ion. Lithium Ion batteries are a high energy density, 3.6V battery. It uses lithium metallic oxide in its positive electrode, or cathode, and carbon material in its negative electrode, or anode. Lithium ions inside the battery transfer between the positive electrode and the negative electrode during charge or discharge.

### SUMMARY OF THE INVENTION

In one aspect the invention is a battery pack for an electronic device, the battery pack comprising: a housing; at least one battery cell associated with the housing; at least one memory element associated with the housing; at least one electrical connection associated with the housing for supplying power from the battery cell to the electronic device; and at least one communication interface associated with the housing for receiving data from the electronic device for storage in the memory element and/or for sending data from the memory element to the electronic device.

In another aspect, the invention is an apparatus comprising a battery pack for an electronic device, the battery pack comprising: a housing; at least one battery cell associated with the housing; at least one memory element associated with the housing; at least one electrical connection associated with the housing for supplying power from the battery cell to the electronic device; and at least one communication interface associated with the housing for receiving data from the electronic device for storage in the memory element and/or for sending data from the memory element to the electronic device; and the electronic device powered by the battery pack; and an electronic device that recharges the battery cell and/or sends data to the memory element and/or receives data from the memory element.

In still another aspect, the invention is a method for storing and accessing data from an electronic device powered by a battery pack, the method comprising: storing data generated by the electronic device using a memory element associated with the battery pack; downloading the data stored within the memory element to a computer; and accessing the data using the computer for analysis or other use.

Another aspect of the invention is a method of securing an apparatus wherein the apparatus comprises an electronic device and a battery pack comprising: a housing; at least one battery cell associated with the housing; at least one memory element associated with the housing; at least one electrical connection associated with the housing for supplying power from the battery cell to the electronic device; and at least one communication interface associated with the housing for receiving data from the electronic device for storage in the memory element and/or for sending data from the memory element to the electronic device; the method comprising: downloading security data to the memory element associated with the battery pack wherein the security data is at least one of: a authorization code and a location restriction; coupling the battery pack with the electronic device; and uploading the security data to the electronic device; wherein the electronic device is configured to poll its environment or prompts a user for an input related to the security data and to take protective measures if the predetermined response from the user or environment does not occur.

In still another aspect, the invention is a system for advertising goods and services and/or providing data to operators of electronic devices having battery packs comprising supplying battery packs to owners/operators of electronic devices wherein: the electronic devices use the battery packs for power; the electronic device has an interface that is or can be configured to accept data from the battery pack; the battery pack has a housing and: at least one battery cell associated with the housing; at least one memory element associated with the housing; at least one electrical connection associated with the housing for supplying power from the battery cell to the electronic device; and at least one communication interface associated with the housing for receiving data from the electronic device for storage in the memory element and/or for sending data from the memory element to the electronic device; the memory element of the battery pack is preloaded with the advertising and/or data; and the advertising and/or data uploads to the electronic device when the battery pack is interfaced to the electronic device.

### BRIEF DESCRIPTION OF THE DRAWINGS

The invention is further defined by the accompanying drawings, wherein like numerals refer to like parts throughout, and in which:

FIG. 1 is an illustration of a battery of the invention.

### DETAILED DESCRIPTION OF THE INVENTION

The present invention, in one embodiment, is a battery pack for an electronic device, the battery pack including: a housing; at least one battery cell associated with the housing; at least one memory element associated with the housing; at least one electrical connection associated with the housing for supplying power from the battery cell to the electronic device; and at least one communication interface associated with the housing for receiving data from the electronic device for storage in the memory element and/or for sending data from the memory element to the electronic device. The housing useful with the invention may be designed to specially fit a single device or it may be designed to be useful with a multiplicity of devices designed to use a common or “universal” battery pack.

The battery cells useful with the invention may be any known to be useful to those of ordinary skill in the art of powering electronic devices. For example, the batteries may by rechargeable or non-rechargeable. If the battery cell is a non-rechargeable battery cell, then in some embodiments it is a “dry cell” battery.

When the batteries cell is a rechargeable cell, it can be a wet battery such as a lead/sulfuric acid battery or it may be a one of the more common reachable batteries. For example, it may be a nickel cadmium, nickel metal hydride, or lithium ion battery. Any such conventional battery may be used with the method of the invention. Further, any non-conventional battery that may be used to provide power to an electronic device may be used with the method of the invention.

The memory element useful with the present invention is any that can be used to store data within the battery pack. In some embodiment, the memory element consists of dynamic random access memory (DRAM). This type of memory is well known to those of ordinary skill in the art. It often comes in two forms known as DIMMS and RIMMS. Further, this type of memory often further classified as synchronous DRAM (SDRAM) and then further classified as DDR (or double rate SDRAM).

Memory elements that do not change state when un-powered are also useful with the method of the invention. For example, flash memory devices, particularly NAND type flash memory devices, are particularly useful with the present invention. While any type of memory unit may be used with the invention, especially those types of memory units that draw little or no power when unused may be particularly desirable for use with the present invention.

In one embodiment of the invention, the battery pack includes an electrical connection for supplying power from the battery element to an electronic device. This connection may be of a plug type, but it may also be of any type known to be useful to those of ordinary skill in the art of powering electronic devices.

In an embodiment of the invention, the battery pack includes a communication interface. The communication interface may be a hard wired interface, that is one that connects to an electronic device using wire leads. In this embodiment, the communications interface may be a part of the electrical connection and could use the same connection as the conductor for power. In one embodiment, the interface is a universal serial bus interface. In another embodiment, the interface is a parallel port or an RS232 interface.

In an alternative embodiment, the communications interface may also be a wireless device. Any device capable to producing at least a one way communication with an electronic device may be used. In some embodiments, the communication interface is capable of two-way communication with the device and is a radio modem device, such as those marketed using the BLUETOOTH® trademark.

The battery packs of the invention may include a second interface. The second interface may be useful for communicating with a second electronic device and, in at least one embodiment; the second interface is a universal serial bus interface.

In employing the method of the invention, the battery pack may be operatively coupled to an electronic device. While any electronic device that may be powered by a battery pack may be used with the method, in some embodiment, the electronic device is a portable computer; a cell phone, a mobile phone, a personal data assistant, a pager, a portable audio/video media player, a sensor, or a military device. The battery pack may be operatively coupled, that is it may be connected so that it can supply power to the device, where the battery pack is supported on or even within the electronic device. In an alternative embodiment, the battery pack is unsupported by the electronic device and operatively coupled using a cable or the like.

In one embodiment of the invention, the battery pack further includes a microprocessor. Any microprocessor that can be incorporated into the battery pack and is known to those of ordinary skill in the art may be used with the invention.

In yet another embodiment, the battery pack further includes a device for interpreting the location of the battery pack using the global positioning satellites. Such device, commonly known as GPS devices may be incorporated in any way known to be useful to those of ordinary skill in the art.

The battery packs of the invention may include a flash card reader. The flash card may be of any format. For example, the flash card reader may be a Secure Digital (SD), CompactFlash (CF), Memory Stick (MS), MultiMediaCard (MMC) xD-Picture Card (xD) and SmartMedia (SM). Any such flash card reader may be used with the apparatus of the invention.

In one embodiment of a method of the invention, a battery pack of the invention is connected to a device that functions to recharge the battery cell. Many battery chargers use a dual rate charge sequence in which the battery under charge is charged at a fast rate for a period of time, and then charged at a slower or “trickle” rate once the battery has reached a predetermined charge level. Rapid charge sequences are terminated by using either an inflection in the battery voltage versus time (V), or inflection in the temperature versus time (T), or when the battery reaches a certain voltage constant current constant voltage (CC-CV). At this point, typically the charger switches to a lower rate of charge. This lower rate of charge could be a fixed lower charge rate, or a variable rate, which is lower than the full rate. This rate is called a trickle charge rate or a top-off charge rate. For Lithium Ion batteries, this rate is adjusted so that the battery voltage does not exceed a predetermined voltage value. This is known as the CV portion of the CC-CV profile.

Lithium Ion batteries are typically charged by using the CC-CV method. A CC-CV method algorithm charges the battery at a fixed current rate up to a predetermined voltage. Once the predetermined voltage is achieved, the charger switches to a trickle or slower charge rate. Any such method or methods of recharging a battery may be used with the method of the invention.

In the method of at lease some embodiments of the invention, the device which is used to recharge the battery also functions to retrieve data and/or write data to the memory element of the battery pack. This can occur either at different times or simultaneously. For example in one embodiment, the battery pack may be operatively connected to the recharging device and the recharging step initiated immediately, and then, later in time, an operator may initiate a data dump from the battery pack's memory element. In an alternative embodiment, the operator may, instead of doing a data dump, upload new data to the memory element.

One application of a battery pack of the invention may be using the memory element to store data from an application where the electronic device needs to be quickly redeployed. In this embodiment, the data generated by the electronic device is stored either in real time or by means of an operator generated data dump to the battery pack. The battery pack is removed from the electronic device and replaced with a second, fresh (or recharged) battery pack. The first battery pack is then recharged and simultaneously data from the memory element is downloaded to a computer. The data can then be used for analysis or any other use. This allows for a faster reemployment of the device because it is not necessary to have the device itself to download the data to a venue where it may be used or analyzed. This is especially convenient when the electronic device is bulky, concealed, or subject to reconfiguration if moved.

The battery pack may also be used to power a device used to download the data. For example, the battery pack may be used to power a flash card writer to transfer the data to a flash card. The flash card may be removed and transferred to a computer.

While the data, in some embodiments of the invention, which is stored in the memory element of the battery packs, is stored in real time, in other embodiment, the data is not stored in real time. As already described, the data generated by the electronic device may be first stored in a memory element of the electronic device and then transferred to the battery pack at a later time, possibly initiated by an operator or a preprogrammed interval. In another embodiment, the data is generated by the electronic device but then transferred to the memory element of the battery pack using a buffering process.

While the methods of the invention may be used in many applications, one application for which they may be very suitable is security. One such method is a method of securing an apparatus wherein the apparatus comprises an electronic device and a battery pack comprising: downloading security data to the memory element associated with the battery pack wherein the security data is at least one of: a authorization code and a location restriction; coupling the battery pack with the electronic device; and uploading the security data to the electronic device; wherein the electronic device is configured to poll its environment or prompts a user for an input related to the security data and to protective measures if the predetermined response from the user or environment does not occur.

In such a method, the security data may be an authorization code and the device may be configured to poll its environment for a signal transmitted by a device worn by an authorized user. In an alternative embodiment, the operator may merely manually enter the authorization code. In still another embodiment, the security data may be a location restriction and the electronic device may use an onboard GPS device or a GPS device located within the battery pack to confirm that the device is operating within the authorized area.

When used to secure a device, the method of the invention may further include at least one of: allowing the electronic device to continue to operate in a manner that would give an operator no indication that the electronic device was taking protective measures and then: transmitting a wireless signal that the device is in unauthorized hands; or producing erroneous data. In another embodiment, the electronic device or the battery pack may simply turn off power to the electronic device. In still another embodiment, the electronic device or the battery pack may initiate a sequence where at least one of the data and electronic components in the electronic device or battery pack are destroyed.

Another embodiment of the security aspect of the invention may be implemented by incorporating a timer or clock element or using a clock circuit already present on/in an element of a battery pack of the application. A set of logic instructions can be implemented that, after a period of time preselected and hard coded or, in the alternative, entered by the user, the data collected is destroyed/erased. This could be useful to prevent unauthorized access to data when rechargeable batteries are reused. In another but similar embodiment, the same feature of a battery pack of the invention could be used to cause the battery and/or an electronic device coupled with the battery pack to “self destruct.” Other security measures such as those described in the paragraph immediately above may also be implemented.

The use of a clock or timing element may be particularly useful in embodiments such as to prevent unauthorized commercial use. In a commercial situation where a device using a battery pack of the application is rented for a set time, the clock may be used to prevent use after expiration of the rental time. The timing element may be used to ensure that a location signal may be sent while there is sufficient power to drive a signaling device. The timing element may be used to initiate any function within the capabilities of the elements on/in the battery pack itself or any electronic device coupled with the battery pack (including those wirelessly coupled).

The battery packs of the application may also be used for performance monitoring and loss prevention in a commercial establishment. For example, the GPS location of a battery pack and a time stamp could be recorded to ensure that an employee was patrolling rather than remaining stationary. Similarly, if used in conjunction with a security device on a high-ticket item, the data recorded by a battery pack of the invention could be used to correlate removal of the item with a particularly employee.

The battery packs of the invention may also be additionally equipped with other's encryption or decryption devices. For example, in one embodiment of the invention, a battery pack may be modified to include hardware encryption/decryption devices such as the ROCKWELL COLLINS® Selective Availability Anti-Spoofing Module (SAASM) which is used by the military to access precision GPS data. Such a modification may allow an easy upgrade for military use of the battery packs.

Another application for which the invention may be used is advertising. In one embodiment, the invention is a system for advertising goods and services and/or providing data to operators of electronic devices having battery packs comprising supplying battery packs to owners/operators of electronic devices wherein: the electronic devices use the battery packs for power; the electronic device has an interface that is or can be configured to accept data from the battery pack; the battery pack has a housing and: at least one battery cell associated with the housing; at least one memory element associated with the housing; at least one electrical connection associated with the housing for supplying power from the battery cell to the electronic device; and at least one communication interface associated with the housing for receiving data from the electronic device for storage in the memory element and/or for sending data from the memory element to the electronic device; the memory element of the battery pack is preloaded with the advertising and/or data; and the advertising and/or data uploads to the electronic device when the battery pack is interfaced to the electronic device. In an embodiment of this type, the advertiser would pay a fee to have the data and/or advertising uploaded to the battery pack.

Advertisers could upload even multimedia files including, but not limited to music, video, books and/or games. When the battery packs are used to power cell phones or video games, such files could be used either to tease the user of electronic devices to purchase the products, or the advertiser could even use this method as a means of delivering product. In such an application, the files could be delivered and then unlocked or otherwise rendered playable for a fee.

One embodiment of such a method of the invention includes using a number of different outlets for providing such battery packs to customers. In one embodiment, the battery packs could be delivered using a vending machine; in another they could be exchanged via mail order or home delivery, either by sale, subscription or rental. An advantage to such embodiments is that they can be used to lower the costs of the batteries, the advertising fees being used to, in effect subsidize the cost of the batteries.

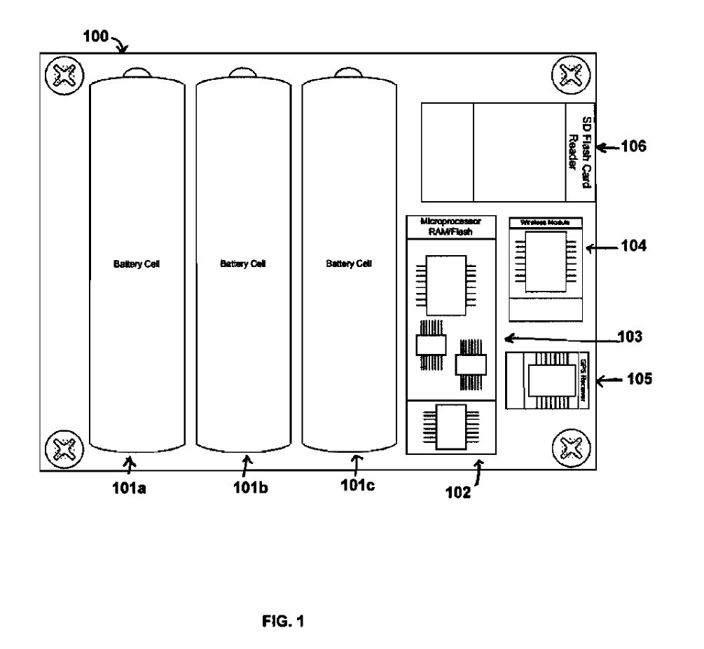

Turning now to FIG. 1, an embodiment of the invention is shown wherein a housing (100) includes three battery cells (101a, 101b, 101c); a microprocessor with both RAM (102) and Flash Memory (103), a wireless modem (104), a GPS receiver (105), and a Flash Card Reader (106). The battery cells are used to power an electronic device. The GPS receiver may be used by ether an electronic device operatively coupled to the battery pack or the battery pack's own microprocessor to determine the battery packs spatial location. The flash drive may be used to input data either into memory of the battery pack using the microprocessor. The wireless modem may be used to interface either a device being powered by the battery pack or another separate electronic device for one way or two way communication.

### EXAMPLES

The following examples are provided to illustrate the present invention. The examples are not intended to limit the scope of the present invention and they should not be so interpreted.

### Hypothetical Example 1

A military device useful for determining the location of gunshots is used in an urban environment in order to facilitate a quick response by authorities against insurgent forces. This device uses a battery pack of the invention to for power. Prior to employing the device, the authorities program the device such that it cannot be used outside of an area specified by geographic coordinates. The specified geographic coordinates are stored within the memory of the battery pack in an encrypted format.

After the device is employed, it is discovered by insurgent forces. The insurgent forces are motivated to use the device to discover the location of snipers employed by the authorities. The insurgents move the device to different location outside of the authorized geographic coordinates. The microprocessor of the electronic device, following a preprogrammed instruction to poll its location, returns a result indicating that the device is now outside of its allowed operating area.

The device is activated by the sound of a gunshot, in this instance a shot taken by a sniper employed by the authorities. Operating in a security violation mode, the electronic device displaces the location of the gunshot by 50 meters in two directions. The insurgents, in attempting to return fire, reveal their location and become subject to return fire from the authority's forces.

### Hypothetical Example 2

A manufacturer of software useful with cell phones contracts with provider of battery packs of the invention having an interface compatible to cell phones to preload demonstration software on a quantity of such battery packs. In return for this, the software manufacturer pays to the battery pack provider a fee equal to 70% of the retail cost of the battery packs. The battery pack provider then offers for sale to the public, using both vending machines located with airports, malls, and other public places; and brick and mortar shops offering batteries to cell phone users, the battery packs preloaded with the demo software at a price which is 50% less than the cost of conventional batteries.

### Hypothetical Example 3

A manufacturer of battery operated video games having a wireless interface for uploading or downloading software pays to a provider of battery packs of the invention to provide to the manufacture a quantity of battery packs having both a wireless interface and a memory element. The video game manufacturer then offers a subscription service to the public wherein the public may purchase battery packs preloaded with software for the videogames.

What is claimed is:

1. A battery pack for an electronic device, the battery pack comprising:
a housing;
at least one battery cell associated with the housing;
at least one memory element associated with the housing;
at least one electrical connection associated with the housing for supplying power from the battery cell to the electronic device; and
at least one communication interface associated with the housing for receiving data from the electronic device for storage in the memory element and/or for sending data from the memory element to the electronic device.

2. The battery pack of claim 1 wherein the battery pack is operatively coupled to the electronic device.

3. The battery pack of claim 1 wherein the battery pack is supported on or within the electronic device.

4. The battery pack of claim 1 wherein the battery cells have a lithium-manganese chemistry or a spinel chemistry.

5. The battery pack of claim 1 further comprising a microprocessor.

6. The battery pack of claim 5 further comprising a GPS receiver.

7. The battery pack of claim 5 further comprising a wireless interface.

8. The battery pack of claim 5 further comprising a flash card reader.

9. The battery pack of claim 5 further comprising a second communication interface for communication with a second electronic device.

10. The battery pack of claim 9 wherein the second communication interface is a USB port.

11. The battery pack of claim 5 wherein the battery pack is connectable to a device that functions to recharge the battery cells and/or to retrieve data from or write new data to the memory element.

12. The battery pack of claim 5 further comprising a timing element.

13. The battery pack of claim 5 further comprising an encryption/decryption module.

14. An apparatus comprising a battery pack of claim 1 and:
an electronic device powered by the battery pack; or
an electronic device that recharges the battery cell and/or sends data to the memory element and/or receives data from the memory element.

15. The apparatus of claim 14 wherein the electronic device powered by the battery pack is a portable computer; a cell phone, a mobile phone, a personal data assistant, a portable audio/video media player, a portable gaming device, a pager, a sensor, or a military device.

16. A method for storing and accessing data from an electronic device powered by a battery pack, the method comprising:
storing data generated by the electronic device using a memory element associated with the battery pack;
downloading the data stored within the memory element to a computer; and
accessing the data using the computer for analysis or other use.

17. The method of claim 16 further comprising analyzing data generated by an electronic device powered by a battery pack, the method comprising:

18. The method of claim 16 further comprising recharging the battery pack and downloading data from the memory element using an electronic device other than the electronic device powered by the battery pack.

19. The method of claim 18 further comprising reemploying the electronic device powered by the battery pack using a second battery pack.

20. The method of claim 18 wherein the battery pack is recharged and the data is downloaded simultaneously.

21. The method of claim 18 wherein recharging the battery pack is commenced upon connection with the electronic device other than the electronic device powered by the battery pack and the data is downloaded at a time selected by an operator.

22. The method of claim 16 wherein the data stored within the memory element is stored in real time.

23. The method of claim 16 wherein the data stored within the memory element is first stored in a buffer located within the electronic device powered by the battery pack and then downloaded to memory element associated with the battery pack.

24. A method of securing an apparatus wherein the apparatus comprises an electronic device and a battery pack of claim 1, the method comprising:
downloading security data to the memory element associated with the battery pack wherein the security data is at least one of: a authorization code and a location restriction;
coupling the battery pack with the electronic device; and
uploading the security data to the electronic device;
wherein the electronic device is configured to polls its environment or prompts a user for an input related to the security data and to protective measures if the predetermined response from the user or environment does not occur.

25. The method of claim 24 wherein the security data is an authorization code and the electronic device polls its environment for a signal transmitted by a device worn by an authorized user.

26. The method of claim 24 wherein the security data is an authorization code and the electronic device is configured to require an operator to enter an associated code.

27. The method of claim 24 wherein the security data is a location restriction and the electronic device uses a GPS signal to confirm that the electronic device is operating within the location restriction.

28. The method of claim 24 wherein the protective measures include at least one of:
the electronic device continuing to operate in a manner that would give an operator no indication that the electronic device was taking protective measures and then:
transmitting a wireless signal that the device is in unauthorized hands; or
producing erroneous data;
the electronic device or the battery pack turning off power to the electronic device; and
the electronic device or the battery pack initiating a sequence where at least one of the data and electronic components in the electronic device or battery pack are destroyed.
